(19) United States
(12) Patent Application Publication
(10) Pub. No.: US 2005/0288380 A1
(43) Pub. Date: Dec. 29, 2005

(54) Emulsifier/demulsifier system

(76) Inventors: Ian MacPherson, Richmond, VA (US); Richard Edward Kuhlman, Southfield, MI (US); Michael J. Milo, Sandy Hook, VA (US)

Correspondence Address: DENNIS H. RAINEAR, CHIEF PATENT COUNSEL, ETHYL CORPORATION, 330 SOUTH FOURTH STREET, RICHMOND, VA, 23219, US

(21) Appl. No.: 10/879,906

(22) Filed: Jun. 29, 2004

(51) Int. Cl. B01F 17/00

(52) U.S. Cl. 516/69

(57) ABSTRACT

An emulsifier/demulsifier system is selected for use with emulsified oil systems such as metal working lubricants. The emulsifier includes an alkyl substituted succinate such as polyisobutylene succinic anhydride. The demulsifier may include a low hydrophilic lipophilic balance surfactant. Other emulsified oil systems which may benefit from the particular emulsifiers and demulsifiers includes oil field chemicals such as drilling fluids and cementing chemicals, paper chemicals, explosive emulsions, rock drill lubricants, and mining lubricants.

The present invention relates to emulsifiers and demulsifiers and combinations thereof for use with emulsified oil systems such as metalworking lubricants. Specifically, the emulsifier may include an alkyl substituted succinate such as polyisobutylene succinic anhydride. The demulsifier may include a low HLB surfactant.

### BACKGROUND

A large portion of cutting and machining lubricant is based on an oil in water emulsion. This presence of water in the fluid has many advantages including cost and cooling efficiency. For the fluid to perform efficiently, the emulsion needs to be strong and the tendency for the oil phase to separate from the water phase is overcome with a variety of emulsification agents (known as emulsifiers). At the end of the fluid's useful life, it is desirable to then separate the oil phase from the water phase, in order to minimize the disposal costs, and to minimize the negative impact of fluid disposal on the environment. Often, this separation is achieved by adding strong acids to the fluid, followed perhaps by neutralization. This acidification and neutralization step results in cost to the user in the form of handling hazardous materials, storing these materials and other costs.

### SUMMARY

Accordingly, it is an object of the present invention to overcome the foregoing drawbacks and disadvantages of existing emulsified oil systems such as metalworking lubricants. According to the present invention, an emulsifier includes a metal-containing detergent and/or an alkyl substituted succinate. A demulsifier includes a low hydrophilic lipophilic balance (HLB) surfactant.

In one example, an emulsifier for use in an emulsified oil system, the emulsifier comprises a polyisobutylene succinic anhydride derived from a polyisobutylene having an average molecular weight of about 500 to about 1250. In another example, an emulsifier for use in a emulsified oil system, the emulsifier comprises a polyisobutenyl succinimide ashless dispersant formed from reacting polyisobutenyl succinic anhydride with a polyamine.

In an alternative example, a demulsifier for use in an emulsified oil system, the demulsifier comprises a surfactant having a hydrophilic lipophilic balance value of less than about 5.0.

In a further example, an emulsified oil in water composition comprising an emulsifier comprising a polyisobutylene succinic anhydride derived from a polyisobutylene having an average molecular weight of about 500 about 1250. This composition may further comprise a demulsifier comprising a surfactant having a hydrophilic lipophilic balance value of less that about 5.0.

In a still further example, a method of breaking an emulsified oil system, the method comprises the steps of providing an emulsion comprising an emulsifier, wherein the emulsifier comprises a polyisobutylene succinic anhydride derived from a polyisobutylene having an average molecular weight of about 500 to about 1250, and adding to the emulsion a demulsifier comprising a surfactant having a hydrophilic lipophilic balance value of less than about 5.0.

### DETAILED DESCRIPTION

The present invention includes replacing or supplementing the emulsification agent in emulsified oil systems with a chemistry which forms strong and stable emulsions for efficient performance, while also designing this emulsification agent so that on addition of a suitable surfactant, the emulsion “breaks” thus facilitating easy disposal.

The specific chemical nature of a typical emulsifier falls into two general classes:

a) a metal detergent such as a sulfonate, phenate, salycilate, phosphonate-phenate, or carboxylate; or

b) an alkyl substituted succinate, such as polyisobutylene succinic anhydride (PIBSA) or derivatives thereof. Traditionally, the PIBSA emulsifiers used are derived from polyisobutylenes having molecular weights of at least about 1350.

In one example of a PIBSA that may be used as described herein, the alkyl substituted succinate is a polyisobutylene succinic anhydride derived from a polyisobutylene having an average molecular weight as determined by gel permeation chromatography in the range of about 500 to about 1250, or alternatively about 950.

In another example, the emulsifier is a polyisobutenyl succinimide ashless dispersant formed from reacting, contacting or interacting a polyisobutenyl succinic anhydride with a polyamine such as triethylene tetramine (TETA) in a mole ratio of less than 2.0 but more than 1.3 moles of said PIBSA per mole of polyamine. Examples of other polyamines that may be used include, but are not limited to, aminoguanidine bicarbonate (AGBC), diethylene triamine (DETA), tetraethylene pentamine (TEPA), pentaethylene hexamine (PEHA), heavy polyamines, and mixtures thereof. A heavy polyamine is a mixture of polyalkylenepolyamines comprising small amounts of lower polyamine oligomers, such as TEPA and PEHA, but primarily oligomers with 7 or more nitrogens, 2 or more primary amines per molecule, and more extensive branching than conventional polyamine mixtures. Other examples of succinimide reaction polyamines and other reagents are set forth in U.S. Pat. No. 6,548,458 B2, incorporated by reference herein in its entirety.

The demulsification surfactant for use as described herein is optimized to work with the specific emulsifier chosen, and can be of any low HLB value type surfactant. HLB is a method of characterizing surfactants based on their relative affinity for water and oil. Generally, higher HLB numbers are assigned to surfactants with a high affinity for water, low HLB numbers are assigned to surfactants which are more lipophilic. In many cases blends containing two or more surfactants may be used to give optimum performance. Often, higher HLB number surfactants will stabilize oil in water emulsions of the type normally used in cutting fluid and other metalworking applications. Usually, mixtures of emulsification surfactants are used or emulsifiers which are themselves broad mixtures of molecular weight in order to bring stability to the system. In order to demulsify or separate what is essentially a stable emulsion, it has been discovered herein to require the use of both special emulsifiers and demulsifiers which are tailored for this effect.

The net HLB number of the surfactant system must be changed if the stable emulsion formed is to be broken. To effect this change a very low HLB number surfactant is added. However, not all surfactants meeting these categories of HLB are likely to work. The surfactants chosen must be mutually compatible. Another theory of this type of emulsion separation (Demulsibility) is that the low HLB surfactant when added to the emulsion will tend to promote the formation of water in oil emulsions. This causes the emulsified system to fall apart or demulsify. Obviously, the amount and chemical type of low HLB surfactant added should be chosen so that the desired separation is achieved, and that a stable water in oil (invert) emulsion is not formed.

Low HLB surfactants having an HLB value of less than about 5.0, or alternatively less than about 2.0, or still further alternatively less than about 1.0 can be successful demulsifiers. A commercially available, low HLB surfactant that has been a successful demulsifier when used with a PIBSA (950 MW PIB) emulsifier is an ethylene oxide/propylene oxide copolymer such as Pluronic L121.

Demulsification packages may comprise multiple chemicals mixed together. These combinations may include combinations of surfactants, but may also include combinations of surfactants and high molecular weight oil-soluble polymers. The molecular weight of this oil soluble polymer varies, but can be around 1 million or higher. This polymer may be, for example, an olefin copolymer, a polymethacrylate or polyacrylate or a polyisobutylene. Polyisobutylenes of molecular weight of 1 million or higher, for instance at least 1.3 million, are available in a variety of forms, but most conveniently as a dilute solution in oil. Examples of these include Paratac (Infineum), HiTEC® 152 (Ethyl), HiTEC® 154 (Ethyl), TecGARD® 400 (Ethyl), Functional V-172 (Functional Products), Functional V-176 (Functional Products). These brands of high molecular weight polymer solutions are marketed as both tackiness additives and as mist control agents. The high molecular weight of these polymers renders them likely to shear under thermal or mechanical stress. This shearing property is a disadvantage in many applications where tackiness or demist properties are desired. In this application, shear stability is not a concern. Shear unstable polymers are therefore suitable, though not necessarily preferred, for this application.

### EXAMPLE 1

A soluble base is prepared by contacting the following ingredients:

| | |
|---|---|
| 100 Naphthenic oil | 82.5% |
| Tall Oil Westvaco M-28B | 2.3% |
| Tripropylene glycol methyl ether (mixed isomers) | 1.1% |
| Richmond, VA Tap Water | 0.5% |
| KOH 45% | 1.3% |
| Lubrizol Syn-ester Gy-241 | 1.6% |
| Polyisobutenyl succinimide ashless dispersant | 12.9% |
| derived from 950MW polyisobutylene, formed from | |
| reacting polyisobutenyl succinic anhydride with | |
| a polyamine | |
| AMP-95 (2-Amino-2-Methyl-1-Propanol) | 1.5% |
| NP-9 (para- nonyl phenol) | 0.6% |

10% of this concentrate was then added to 90% tap-water to give a stable emulsion. A demulsifier, Sanyo LB 1800X (Polyoxypropylenebutylether) was then added to the emulsion, which subsequently formed two layers of oil soluble and water soluble parts. The water layer was cloudy.

### EXAMPLE 2

A Soluble base is prepared by contacting the following ingredients:

| | |
|---|---|
| 100 Naphthenic oil | 82.5% |
| Tall Oil Westvaco M-28B | 2.3% |
| Tripropylene glycol methyl ether (mixed isomers) | 1.1% |
| Richmond, VA Tap Water | 0.5% |
| KOH 45% | 1.3% |
| Lubrizol Syn-ester Gy-241 | 1.6% |
| Polyisobutenyl succinimide ashless dispersant | 12.9% |
| derived from 950MW polyisobutylene, formed from | |
| reacting polyisobutenyl succinic anhydride with | |
| a polyamine | |
| AMP-95 (2-Amino-2-Methyl-1-Propanol) | 1.5% |
| NP-9 (para- nonyl phenol) | 0.6% |

10% of this concentrate was then added to 90% tap-water to give a stable emulsion. A demulsifier, comprising a mixture of 50 parts of HiTEC 152 polyisobutylene based tackiness additive, and 50 parts of a 10% solution of Pluronic L-121 was then added to the emulsion, which subsequently formed two layers of oil soluble and water soluble parts. The water layer was cloudy.

### EXAMPLE 3

A soluble base is prepared by contacting the following ingredients:

| | |
|---|---|
| 100 Naphthenic oil | 84.1% |
| Tall Oil Westvaco M-28B | 2.3% |
| Tripropylene glycol methyl ether (mixed isomers) | 1.1% |
| Richmond, VA Tap Water | 0.5% |
| KOH 45% | 1.3% |
| Polyisobutenyl succinimide ashless dispersant | 12.9% |
| derived from 950MW Polyisobutylene, formed from | |
| reacting polyisobutenyl succinic anhydride with | |
| a polyamine | |
| AMP-95 (2-Amino-2-Methyl-1-Propanol) | 1.5% |
| NP-9 (para- nonyl phenol) | 0.6% |

10% of this concentrate was then added to 90% tap-water to give a stable emulsion. A demulsifier, comprising a mixture of 50 parts of HiTEC 152 polyisobutylene based tackiness additive, and 50 parts of a 10% solution of Pluronic L-121 was then added to the emulsion, which subsequently formed two layers of oil soluble and water soluble parts. The water layer was cloudy.

### EXAMPLE 4

A soluble base is prepared by contacting the following ingredients:

| | |
|---|---|
| 100 Naphthenic oil | 84.1% |
| Tall Oil Westvaco M-28B | 2.3% |
| Tripropylene glycol methyl ether (mixed isomers) | 1.1% |
| Richmond, VA Tap Water | 0.5% |
| KOH 45% | 1.3% |
| Polyisobutenyl succinimide ashless dispersant | 12.9% |
| derived from 950MW polyisobutylene, formed from | |
| reacting polyisobutenyl succinic anhydride with | |
| a polyamine | |
| AMP-95 (2-Amino-2-Methyl-1-Propanol) | 1.5% |
| NP-9 (para- nonyl phenol) | 0.6% |

10% of this concentrate was then added to 90% tap-water to give a stable emulsion. A demulsifier, Sanyo LB 1800X (Polyoxypropylenebutylether) was then added to the emulsion, which subsequently formed two layers of oil soluble and water soluble parts. The water layer was cloudy.

### EXAMPLE 5

A soluble base is prepared by contacting the following ingredients:

| | |
|---|---|
| 100 Naphthenic oil | 84.0% |
| Tall Oil Westvaco M-28B | 2.3% |
| Tripropylene glycol methyl ether (mixed isomers) | 1.1% |
| Richmond, VA Tap Water | 0.5% |
| KOH 45% | 1.3% |
| Lubrizol Syn-ester Gy-241 | 1.6% |
| polyisobutenyl succinimide ashless dispersant | 12.9% |
| derived from 950MW polyisobutylene, formed from | |
| reacting polyisobutenyl succinic anhydride with | |
| a polyamine | |
| NP-9 (para- nonyl phenol) | 0.6% |

10% of this concentrate was then added to 90% tap-water to give a stable emulsion. A demulsifier, Sanyo LB 1800X (Polyoxypropylenebutylether) was then added to the emulsion, which subsequently formed two layers of oil soluble and water soluble parts. The water layer was cloudy.

### EXAMPLE 6

A soluble base is prepared by contacting the following ingredients:

| | |
|---|---|
| 100 Naphthenic oil | 84.0% |
| Tall Oil Westvaco M-28B | 2.3% |
| Tripropylene glycol methyl ether (mixed isomers) | 1.1% |
| Richmond, VA Tap Water | 0.5% |
| KOH 45% | 1.3% |
| Lubrizol Syn-ester Gy-241 | 1.6% |
| Polyisobutenyl succinimide ashless dispersant | 12.9% |
| derived from 950MW polyisobutylene, formed from | |
| reacting polyisobutenyl succinic anhydride with | |
| a polyamine | |
| NP-9 (para- nonyl phenol) | 0.6% |

10% of this concentrate was then added to 90% tap-water to give a stable emulsion. A demulsifier, comprising a mixture of 50 parts of HiTEC® 152 polyisobutylene based tackiness additive, and 50 parts of a 10% solution of Pluronic L-121 was then added to the emulsion, which subsequently formed two layers of oil soluble and water soluble parts. The water layer was cloudy.

The foregoing examples are directed to a metalworking lubricant. The term “metalworking lubricant” shall mean the fluids described herein for use in connection with cutting and machining tools. Metalworking fluid may comprise a variety of fluids including straight oils, soluble or emulsions, semi-synthetic fluids and synthetic fluids. Emulsion type fluids are often referred to as soluble oils and semi-synthetic fluids. Metalworking fluids herein fall into several classes including coolants, forming oils, treating fluids and preservative fluids. The purpose of the metalworking fluid may be several fold. It may lubricate the tool, remove metal chips from the path of the cutting device, prevent corrosion of the work piece and of the cutting tool, remove heat and other properties. Water being present in the metalworking fluid provides for beneficial heat removal properties and often for low cost.

Depending on the specific application, the following types of chemicals may be present in metalworking fluids: emulsifiers, coupling agents, EP additives, antiwear additives, antioxidants, pH Buffers, oil (Naphthenic, parafinnic or other type), water (tap water, distilled water, deionized water, treated water etc), biocides (bacteriocides and fungicides), foam inhibitors, rust and corrosion inhibitors, and polymers to reduce the tendency for stray mist in the work place. It is often desirable, though not essential, that the metalworking fluid be of a fairly light color. This is mainly to allow clear view of the work piece as it is cut or ground. It is also desirable, though not essential, that the metalworking fluid not give off a strong chemical odor, as this makes the work place undesirable.

Other types of emulsified oil systems may likewise benefit from the emulsifiers, demulsifiers and method described herein. These further emulsification systems include oil field chemicals such as drilling fluids and cementing chemicals, paper chemicals (i.e., chemicals used in the manufacture of paper), explosive emulsions, rock drill lubricants, and mining lubricants, among others. In each of these examples, and in other emulsified oil systems, an emulsifier may be selected and used with a particular demulsifier to break the emulsions that are used in connection with those systems. In this way, disposal of the various emulsions may be enhanced.

A particular benefit of the PIBSA emulsifier described herein, specifically the relatively low molecular weight PIBSA formed from polyisobutylene having a molecular weight of from about 500 to about 1250, involves the inherent compatibility of the metalworking fluids with other lubricants that may be used as part of the same metalworking equipment system. For instance, in the example of a metalworking lubricant, additional oils that may be used as part of that metalworking equipment system utilizing metalworking fluid include cutting oils, oil-based hydraulic oils, slideway oils and industrial gear oils. These are often referred to as “tramp” oils, because they can contaminate the metalworking lubricant. However, many of the so-called tramp oils cause problems of compatibility if they contaminate the metalworking fluid, and may cause the metalworking fluid to need to be disposed of. However, if the metalworking fluid utilizes the emulsification system described herein, then it is possible to choose these other oils for use in the metalworking equipment system so that they also contain this type of chemical. Note that the inclusion of this type of chemical such as a succinimide dispersant in these other oils are not intended as emulsifiers, but rather bring other properties such as cleanliness or additive solubility or sludge and deposit control etc. Some of these industrial lubricants in the market place include the use of PIBSA components, including the low molecular weight products described herein. See for example a patent directed to a gear dispersant, U.S. Pat. No. 5,612,295, that includes a PIBSA derived from a low molecular weight polyisobutylene. That patent is incorporated by reference herein as if set forth in its entirety. When using a metalworking lubricant that has an emulsifier that includes a PIBSA based on a low molecular weight polyisobutylene, the metalworking lubricant can be compatible with the other industrial fluids used in connection with the system such as tramp oils. In this way, the tramp oils are less likely to spoil or detrimentally contaminate the metalworking lubricant.

This invention is susceptible to considerable variation in its practice. Therefore the foregoing description is not intended to limit, and should not be construed as limiting, the invention to the particular exemplifications presented herein above. Rather, what is intended to be covered is as set forth in the ensuing claims and the equivalents thereof permitted as a matter of law.

Applicant does not intend to dedicate any disclosed embodiments to the public, and to the extent any disclosed modifications or alterations may not literally fall within the scope of the claims, they are considered to be part of the invention under the doctrine of equivalents.

1. An emulsifier for use in an emulsified oil system, the emulsifier comprising a polyisobutylene succinic anhydride derived from a polyisobutylene having an average molecular weight of about 500 to about 1250.

2. An emulsifier as described in claim 1, wherein the polyisobutylene succinic anhydride is derived from a polyisobutylene having an average molecular weight of about 950.

3. An emulsifier as described in claim 1, wherein the emulsified oil system is a metalworking lubricant.

4. An emulsifier for use in a emulsified oil system, the emulsifier comprising a polyisobutenyl succinimide ashless dispersant formed from reacting polyisobutenyl succinic anhydride with a polyamine.

5. An emulsifier as described in claim 4, wherein the polyamine is triethylene tetramine.

6. An emulsifier as described in claim 5, wherein the mole ratio of polyisobutenyl succinic anhydride to triethylene tetramine is about 2.0 to about 1.3.

7. An emulsifier as described in claim 4, wherein the polyisobutylene succinic anhydride is derived from a polyisobutylene having an average molecular weight of about 500 to about 1250.

8. An emulsifier as described in claim 7, wherein the polyisobutylene succinic anhydride is derived from a polyisobutylene having an average molecular weight of about 950.

9. An emulsifier as described in claim 4, wherein the emulsified oil system is a metalworking lubricant.

10. A demulsifier for use in an emulsified oil system, the demulsifier comprising a surfactant having a hydrophilic lipophilic balance value of less than about 5.0.

11. A demulsifier as described in claim 10, wherein the surfactant comprises an ethylene oxide/propylene oxide copolymer.

12. A demulsifier as described in claim 10, wherein the hydrophilic lipophilic balance value is less than about 2.0.

13. A demulsifier as described in claim 10, wherein the hydrophilic lipophilic balance value is less than about 1.0.

14. A demulsifier as described in claim 10, wherein the emulsified oil system is a metalworking lubricant.

15. A method of breaking an emulsified oil system, the method comprising the steps of:
providing an emulsion comprising an emulsifier, wherein the emulsifier comprises a polyisobutylene succinic anhydride is derived from a polyisobutylene having an average molecular weight of about 500 to about 1250;
adding to the emulsion a demulsifier comprising a surfactant having a hydrophilic lipophilic balance value of less than about 5.0.

16. A method as described in claim 15, wherein the polyisobutylene succinic anhydride is derived from a polyisobutylene having an average molecular weight of about 950.

17. A method as described in claim 15, wherein the surfactant comprises an ethylene oxide/propylene oxide copolymer.

18. A method as described in claim 15, wherein the hydrophilic lipophilic balance value of said surfactant is less than about 2.0.

19. A method as described in claim 15, wherein the hydrophilic lipophilic balance value of said surfactant is less than about 1.0.

20. A method as described in claim 15, wherein the emulsified oil system is a metalworking lubricant.

21. An emulsified oil in water composition comprising an emulsifier comprising a polyisobutylene succinic anhydride derived from a polyisobutylene having an average molecular weight of about 500 about 1250.

22. A composition as described in claim 21, wherein the polyisobutylene succinic anhydride is derived from a polyisobutylene having an average molecular weight of about 950.

23. An emulsified oil in water composition comprising an emulsifier comprising a polyisobutenyl succinimide ashless dispersant formed from reacting polyisobutenyl succinic anhydride with a polyamine.

24. A composition as described in claim 23, wherein the polyamine is triethylene tetramine.

25. A composition as described in claim 24, wherein the mole ratio of polyisobutenyl succinic anhydride to triethylene tetramine is about 2.0 to about 1.3.

26. A composition as described in claim 23, wherein the polyisobutylene succinic anhydride is derived from a polyisobutylene having an average molecular weight of about 500 to about 1250.

27. A composition as described in claim 26, wherein the polyisobutylene succinic anhydride is derived from a polyisobutylene having an average molecular weight of about 950.

28. A composition as described in claim 23, further comprising a demulsifier comprising a surfactant having a hydrophilic lipophilic balance value of less than about 5.0.

29. A composition as described in claim 21, further comprising a demulsifier comprising a surfactant having a hydrophilic lipophilic balance value of less than about 5.0.

30. A composition as described in claim 29, wherein the surfactant comprises an ethylene oxide/propylene oxide copolymer.

31. A composition as described in claim 29, wherein the hydrophilic lipophilic balance value is less than about 2.0.

32. A composition as described in claim 29, wherein the hydrophilic lipophilic balance value is less than about 1.0.

33. A metalworking lubricant comprising an emulsifier comprising a polyisobutylene succinic anhydride derived from a polyisobutylene having an average molecular weight of about 500 to about 1250.

34. A metalworking lubricant a described in claim 33, further comprising a demulsifier comprising a surfactant having a hydrophilic lipophilic balance value of less than about 5.0.

35. An oil field drilling fluid comprising an emulsifier comprising a polyisobutylene succinic anhydride derived from a polyisobutylene having an average molecular weight of about 500 to about 1250.

36. An oil field drilling fluid as described in claim 35, further comprising a demulsifier comprising a surfactant having a hydrophilic lipophilic balance value of less than about 5.0.

37. A paper chemical comprising an emulsifier comprising a polyisobutylene succinic anhydride derived from a polyisobutylene having an average molecular weight of about 500 to about 1250.

38. A paper chemical as described in claim 37, further comprising a demulsifier comprising a surfactant having a hydrophilic lipophilic balance value of less than about 5.0.

39. An explosive emulsion comprising an emulsifier comprising a polyisobutylene succinic anhydride derived from a polyisobutylene having an average molecular weight of about 500 to about 1250.

40. An explosive emulsion as described in claim 39, further comprising a demulsifier comprising a surfactant having a hydrophilic lipophilic balance value of less than about 5.0.

41. A rock drill lubricant comprising an emulsifier comprising a polyisobutylene succinic anhydride derived from a polyisobutylene having an average molecular weight of about 500 to about 1250.

42. A rock drill lubricant as described in claim 41, further comprising a demulsifier comprising a surfactant having a hydrophilic lipophilic balance value of less than about 5.0.

43. A mining lubricant comprising an emulsifier comprising a polyisobutylene succinic anhydride derived from a polyisobutylene having an average molecular weight of about 500 to about 1250.

44. A mining lubricant as described in claim 43, further comprising a demulsifier comprising a surfactant having a hydrophilic lipophilic balance value of less than about 5.0.

45. A method of lubricating a metalworking system comprising the steps of providing a metalworking lubricant comprising an emulsifier comprising a polyisobutylene succinic anhydride derived from a polyisobutylene having an average molecular weight of about 500 to about 1250; and
contacting the metalworking lubricant with a surface of the metalworking system.

46. A method as described in claim 45, further comprising providing a demulsifier comprising a surfactant having a hydrophilic lipophilic balance value of less than about 5.0; and
adding the demulsifier to the metalworking lubricant.

47. An emulsified oil in water composition comprising an emulsifier comprising a polyisobutenyl succinimide ashless dispersant formed from reacting polyisobutenyl succinic anhydride with a polyamine and further comprising a demulsifier comprising a surfactant package comprising an ethylene propylene oxide copolymer and a high molecular weight oil soluble polymer having a number average molecular weight of at least 1 million.

48. An emulsified oil in water composition comprising an emulsifier comprising a polyisobutenyl succinimide ashless dispersant formed from reacting polyisobutenyl succinic anhydride with a polyamine and further comprising a demulsifier comprising a surfactant package comprising an ethylene propylene oxide copolymer and a high molecular weight oil soluble polyisobutylene having a number average molecular weight of at least 1.3 million.

49. An emulsified oil in water composition comprising an emulsifier comprising a polyisobutenyl succinimide ashless dispersant formed from reacting polyisobutenyl succinic anhydride with a polyamine and further comprising a demulsifier comprising a surfactant package comprising an ethylene propylene oxide copolymer and an oil soluble demist additive.

50. An emulsified oil in water composition comprising an emulsifier comprising a polyisobutenyl succinimide ashless dispersant formed from reacting polyisobutenyl succinic anhydride with a polyamine and further comprising a demulsifier comprising a surfactant package comprising an ethylene propylene oxide copolymer and an oil soluble tackiness additive.

51. A metalworking equipment system comprising:
an emulsified oil system, the emulsifier comprising a polyisobutylene succinic anhydride derived from a polyisobutylene having an average molecular weight of about 500 to about 1250; and
at least one additional oil selected from the group consisting of cutting oil, hydraulic oil, gear oil and slideway oil;
wherein the at least one additional oil comprises an additive comprising a polyisobutenyl succinimide ashless dispersant formed from reacting a polyisobutylene succinic anhydride with a polyamine, wherein the polyisobutylene succinic anhydride was derived from a polyisobutylene having an average molecular weight of about 500 to about 1250.

52. A system as described in claim 51, further comprising a demulsifier comprising a surfactant having a hydrophilic lipophilic balance value of less than about 5.0.
